(19) United States
(12) Patent Application Publication
(10) Pub. No.: US 2023/0291848 A1
(43) Pub. Date: Sep. 14, 2023

(54) INFORMATION PROCESSING APPARATUS, INFORMATION PROCESSING SYSTEM, AND NON-TRANSITORY COMPUTER READABLE MEDIUM

(71) Applicant: FUJIFILM Business Innovation Corp., Tokyo (JP)

(72) Inventor: Yasuhiro ENDO, Kanagawa (JP)

(73) Assignee: FUJIFILM Business Innovation Corp., Tokyo (JP)

(21) Appl. No.: 17/864,815

(22) Filed: Jul. 14, 2022

(30) Foreign Application Priority Data
Mar. 14, 2022 (JP) 2022-039719

(51) Int. Cl. H04N 1/00; H04N 1/44

(52) U.S. Cl. CPC H04N 1/00209; H04N 1/00244; H04N 1/4426

(57) ABSTRACT

An information processing apparatus includes a processor configured to: when receiving an image forming instruction issued to an image forming apparatus, transmit image data and processing information to a server, the processing information including access information regarding access to the information processing apparatus and information for forming an image represented by the image data, and store the image data into the information processing apparatus; when there is a change in the access information, acquire the changed access information and transmits the acquired changed access information to the server; and perform control for transmitting the image data to the image forming apparatus in response to a request from the image forming apparatus for transmission of the image data.

### CROSS-REFERENCE TO RELATED APPLICATIONS

This application is based on and claims priority under 35 USC 119 from Japanese Patent Application No. 2022-039719 filed Mar. 14, 2022.

### BACKGROUND

### (i) Technical Field

The present disclosure relates to an information processing apparatus, an information processing system, and a non-transitory computer readable medium.

### (ii) Related Art

An image forming method is suggested in Japanese Unexamined Patent Application Publication No. 2018-185869. In the image forming method, in a case where, in the process of image formation based on image formation data acquired from an information processing apparatus, the state of an image formation relation unit relating to image formation becomes error and there is image formation data acquired from a server from which image formation is performed after the image formation data acquired from the information processing apparatus, state information regarding the state of the image formation relation unit notified to the server.

An image forming apparatus is suggested in Japanese Unexamined Patent Application Publication No. 2014-045311. After a user account of a cloud service system is logged in, the image forming apparatus uploads image data in association with an ID to a storage service. Once the upload communication for the image data is completed, the image forming apparatus searches the storage service for the image data using the ID as a key, and verifies that the image data is registered in the storage service. In the case where the image data fails to be registered, the image forming apparatus re-uploads the image data.

### SUMMARY

In image formation via a server, a file is downloaded from the server. Therefore, such image formation tends to take a long time compared to image formation via direct connection to an image forming apparatus. However, for example, in the case where direct connection to an image formation apparatus is not able to be established, image formation needs to be performed via a server. It would be troublesome for users to select where to transmit image data, that is, select whether image data is to be stored in the server to form an image or directly transmitted to the image forming apparatus to form an image, every time that image formation needs to be performed.

Aspects of non-limiting embodiments of the present disclosure relate to providing an information processing apparatus, an information processing system, and a non-transitory computer readable medium that are capable of performing image formation without selecting whether image data is to be transmitted to a server or to an image forming apparatus every time that image formation needs to be performed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: when receiving an image forming instruction issued to an image forming apparatus, transmit image data and processing information to a server, the processing information including access information regarding access to the information processing apparatus and information for forming an image represented by the image data, and store the image data into the information processing apparatus; when there is a change in the access information, acquire the changed access information and transmits the acquired changed access information to the server; and perform control for transmitting the image data to the image forming apparatus in response to a request from the image forming apparatus for transmission of the image data.

### BRIEF DESCRIPTION OF THE DRAWINGS

Exemplary embodiments of the present disclosure will be described in detail based on the following figures, wherein:

FIG. 1 is a diagram illustrating a schematic configuration of an image forming system according to an exemplary embodiment;

FIG. 2 is a block diagram illustrating a configuration of a principal part of an electrical system of an image forming apparatus according to an exemplary embodiment;

FIG. 3 is a block diagram illustrating a configuration of a principal part of an electrical system of a cloud server and an information processing apparatus according to an exemplary embodiment;

FIG. 4 is a functional block diagram illustrating a functional configuration of units in an image forming system according to an exemplary embodiment;

FIG. 5 is a diagram for explaining an example of processing patterns based on which printing is performed by an image forming apparatus in an image forming system according to an exemplary embodiment;

FIG. 6 is a diagram illustrating an example or a setting screen displayed on an information processing apparatus;

FIG. 7 is a diagram for explaining an example of the procedure of a process performed in an image forming system according to an exemplary embodiment; and

FIG. 8 is a sequence diagram illustrating an example of the procedure of a process performed in the image forming system according to the exemplary embodiment.

### DETAILED DESCRIPTION

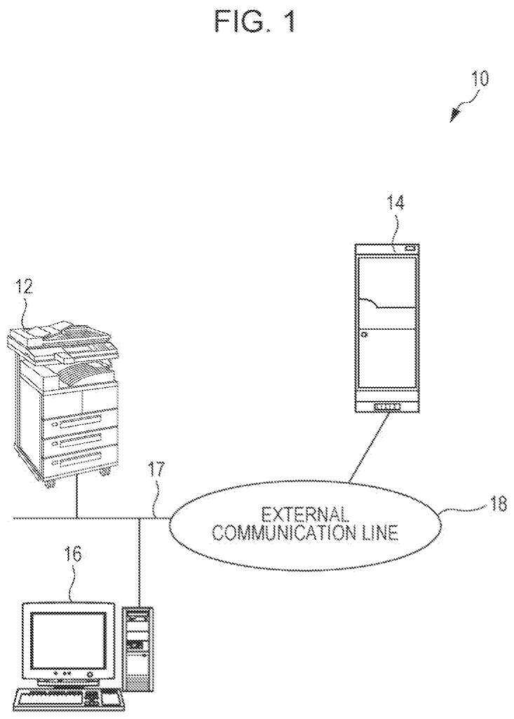

Exemplary embodiments or the present disclosure will be described below with reference to drawings. FIG. 1 is a diagram illustrating a schematic configuration of an image forming system according to an exemplary embodiment. In this exemplary embodiment, an image forming system 10 will be described as an example of an information processing system.

The image forming system 10 according to an exemplary embodiment includes, as illustrated in FIG. 1, an image forming apparatus 12, a cloud server 14 as an example of a server, and an information processing apparatus 16. In this exemplary embodiment, only an image forming apparatus 12, a cloud server 14, and an information processing apparatus 16 are provided. However, a plurality of image forming apparatuses 12, a plurality of cloud servers 14, and a plurality of information processing apparatuses 16 may be provided. Furthermore, the information processing apparatus 16 may be a personal computer or a portable terminal such as a tablet terminal or a smartphone.

The image forming apparatus 12 and the information processing apparatus 16 are connected to an internal communication line 17 such as a local area network (LAN) or an intranet. The internal communication line 17 and the cloud server 14 are connected to an external communication line 18 such as a wide area network (WAN) or the Internet. The image forming apparatus 12, the cloud server 14, and the information processing apparatus 16 are able to perform transmission and reception of various data to and from one another via the internal communication line 17 and the external communication line 18.

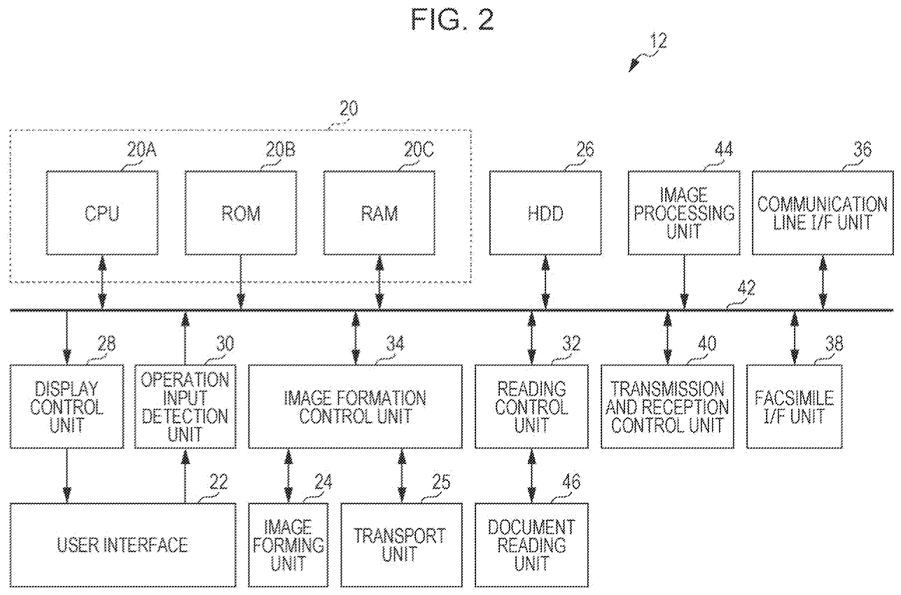

FIG. 2 is a block diagram illustrating a configuration of a principal part of an electrical system of the image forming apparatus 12 according to an exemplary embodiment.

The image forming apparatus 12 according to this exemplary embodiment includes, as illustrated in FIG. 2, a control unit 20 including a central processing unit (CPU) 20A as an example of a second processor, a read only memory (ROM) 20B, and a random access memory (RAM) 20C. The CPU 20A manages the overall operation of the image forming apparatus 12. The RAM 20C is used as a work area or the like when various programs are executed by the CPU 20A. Various control programs, various parameters, and the like are stored in advance in the ROM 20B. In the image forming apparatus 12, components of the control unit 20 are electrically connected to one another by a system bus 42.

In addition, the image forming apparatus 12 according to this exemplary embodiment includes a hard disk drive (HDD) 26 in which various data, application programs, and the like are stored. The image forming apparatus 12 also includes a display control unit 28 that is connected to a user interface 22 and controls display of various operation screens and the like on a display of the user interface 22. The image forming apparatus 12 also includes an operation input detection unit 30 that is connected to the user interface 22 and detects an operation instruction input via the user interface 22. In the image forming apparatus 12, the HDD 26, the display control unit 28, and the operation input detection unit 30 are electrically connected to the system bus 42. An example of the image forming apparatus 12 according to this exemplary embodiment that includes the HDD 26 will be described below. However, the image forming apparatus 12 does not necessarily include the HDD 26 and may include a non-volatile storing unit such as a flash memory.

Furthermore, the image forming apparatus 12 according to this exemplary embodiment includes a reading control unit 32 that controls an optical image reading operation by a document reading unit 46 and a document feeding operation by a document transport unit and an image formation control unit 34 that controls image formation processing by an image forming unit 24 and transport of paper to the image forming unit 24 by a transport unit 25. The image forming apparatus 12 also includes a communication line interface (communication line I/F) unit 36 that is connected to the internal communication line 17 and performs transmission and reception of communication data to and from other external apparatuses such as the cloud server 14 connected to the internal communication line 17 and an image processing unit 44 that performs various types of image processing. The image forming apparatus 12 further includes a facsimile interface (facsimile I/F) unit 38 that is connected to a telephone line, which is not illustrated in drawings, and performs transmission and reception of facsimile data to and from a facsimile apparatus connected to the telephone line. The image forming apparatus 12 also includes a transmission and reception control unit 40 that controls transmission and reception of facsimile data via the facsimile I/F unit 38. In the image forming apparatus 12, the transmission and reception control unit 40, the reading control unit 32, the image formation control unit 34, the communication line I/F unit 36, the facsimile I/F unit 38, and the image processing unit 44 are electrically connected the system bus 42.

With the configuration described above, in the image forming apparatus 12 according to this exemplary embodiment, the CPU 20A accesses the RAM 20C, the ROM 20B, and the HDD 26. Furthermore, in the image forming apparatus 12, the CPU 20A causes the display control unit 28 to control display of an operation screen and information such as various messages on the display of the user interface 22. In the image forming apparatus 12, the CPU 20A causes the reading control unit 32 to control operations of the document reading unit 46 and the document transport unit. In the image forming apparatus 12, the CPU 20A causes the image formation control unit 34 to control operations of the image forming unit 24 and the transport unit 25 and causes the communication line I/F unit 36 to control transmission and reception of communication data. In the image forming apparatus 12, the CPU 20A causes the transmission and reception control unit 40 to control transmission and reception of facsimile data by the facsimile I/F unit 38. Furthermore, in the image forming apparatus 12, the CPU 20A understands content of an operation using the user interface 22 an the basis of operation information detected by the operation input detection unit 30 and performs various types of control based on the content of the operation.

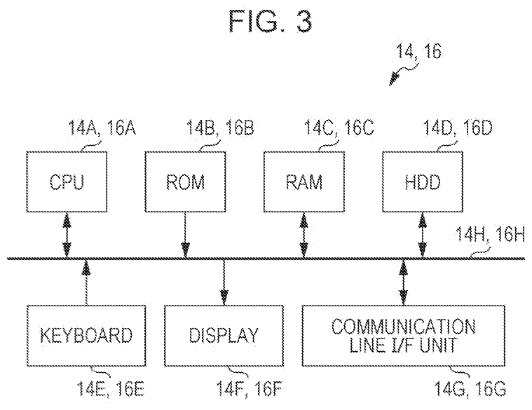

Now, a configuration of a principal part of an electrical system of the cloud server 14 and the information processing apparatus 16 in this exemplary embodiment will be described. FIG. 3 is a block diagram illustrating a configuration of a principal part of an electrical system of the cloud server 14 and the information processing apparatus 16 in this exemplary embodiment. Basically, the cloud server 14 and the information processing apparatus 16 each have a configuration of a typical computer. Thus, a configuration of a principal part of the electrical system of the cloud server 14 will be described as a representative. Explanation for a configuration of a principal part of the electrical system of the information processing apparatus 16 will be omitted, and only corresponding reference signs are indicated in FIG. 3.

The cloud server 14 in this exemplary embodiment includes, as illustrated in FIG. 3, a CPU 14A, a ROM 14B, a RAM 14C, an HDD 14D, a keyboard 14E, a display 14F, and a communication interface (I/F) unit 140. The CPU 14A manages the overall operation of the cloud server 14. Various control programs, various parameters, and the like are stored in advance in the ROM 14B. The RAM 14C is used as a work area or the like when various programs are executed by the CPU 14A. Various data, application programs, and the like are stored in the HDD 14D. The keyboard 14E is used to input various types of information. The display 14F is used to display various types of information. The communication line I/F unit 14G is connected to the external communication line 18 and performs transmission and reception of various data to and from other apparatuses connected to the external communication line 18. The components of the cloud server 14 described above are electrically connected to one another by a system bus 14H. An example of the cloud server 14 in this exemplary embodiment that includes the HDD 14D will be described below. However, the cloud server 14 does not necessarily include the HDD 14D and may include a non-volatile storing unit such as a flash memory. A communication line interface (I/F) unit 16G of the information processing apparatus 16 is connected to the internal communication line 17 and performs transmission and reception of various data to and from other apparatuses connected to the internal communication line 17.

With the configuration described above, in the cloud server 14 in this exemplary embodiment, the CPU 14A accesses the ROM 14B, the PAM 14C, and the HDD 14D, acquires various data using the keyboard 14E, and displays various types of information on the display 14F. Furthermore, in the cloud server 14, the CPU 14A controls transmission and reception of communication data via the communication line I/F unit 14G. The CPU 14A corresponds to an example of a third processor, and the CPU 16A corresponds to an example of a first processor.

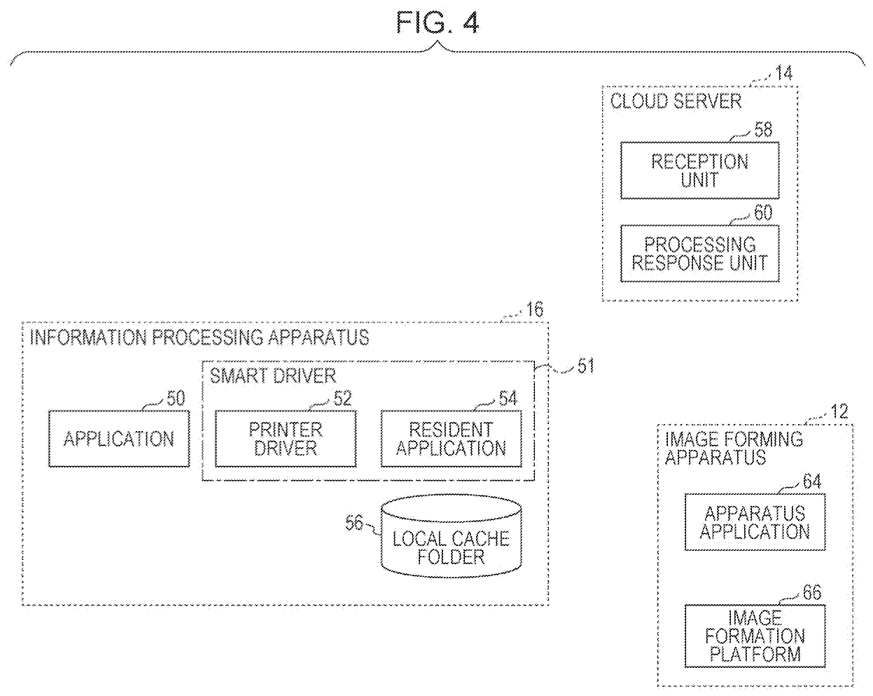

Next, a functional configuration of units in the image forming system 10 according to this exemplary embodiment configured as described above will be described. FIG. 4 is a functional block diagram illustrating a functional configuration of the units in the image forming system 10 according to this exemplary embodiment.

The information processing apparatus 16 includes functions of an application 50 and a smart driver 51.

The application 50 includes various applications having a printing function running on the information processing apparatus 16.

The smart driver 51 includes functions of a printer driver 52 and a resident application 54.

The printer driver 52 performs processing for creating print data as image data in accordance with an instruction from the application 50 and passing the print data to the resident application 54.

The resident application 54 receives print data from the printer driver 52 and responds to a print data acquisition request from an apparatus application 64 of the image forming apparatus 12. The resident application 54 also performs processing for storing print data into a local cache folder 56. The resident application 54 encrypts print data and stores the encrypted print data into the local cache folder 56 so that security of the print data is ensured. However, simplified processing in which non-encrypted print data is stored may be performed. Alternatively, setting as to whether or not to encrypt print data may be performed.

Furthermore, the resident application 54 starts, and monitors whether there is a change in a routing table of an operating system (OS). When there is a change in the routing table of the OS, the resident application 54 acquires an Internet protocol address (IP address) corresponding to a default gateway. Furthermore, the resident application 54 transmits the acquired IP address and a document identification (ID) for identifying a document stored in the local cache folder 56 to the cloud server 14. The routing table represents path information in a table format that holds the list of paths to destinations on individual networks.

The cloud server 14 includes functions of a reception unit 58 and a processing response unit 60.

The reception unit 58 receives from the resident application 54 processing information indicating content of processing, such as printing settings, and print data. The processing information includes setting conditions for printing, such as the number of copies to be printed, image quality, and color/monochrome, and a document name. The document name may be the original file name or the title of a webpage. The document name varies depending on the application that performs printing. Furthermore, in this exemplary embodiment, the processing information further includes access information such as an IP address. However, the processing information may be separated from the access information.

The processing response unit 60 responds to various requests such as a processing list acquisition request from the apparatus application 64 of the image forming apparatus 12.

The image forming apparatus 12 includes functions of the apparatus application 64 and an image formation platform 66.

The apparatus application 64 includes functions for performing processing for displaying a screen for a processing list and the like on the user interface 22 and for passing print data acquired from the cloud server 14 or the resident application 54 to the image formation platform 66.

The image formation platform 66 provides a basic function as the image forming apparatus 12, such as display on the user interface 22 and image formation based on print data. For example, the image formation platform 66 includes an application programming interface (API).

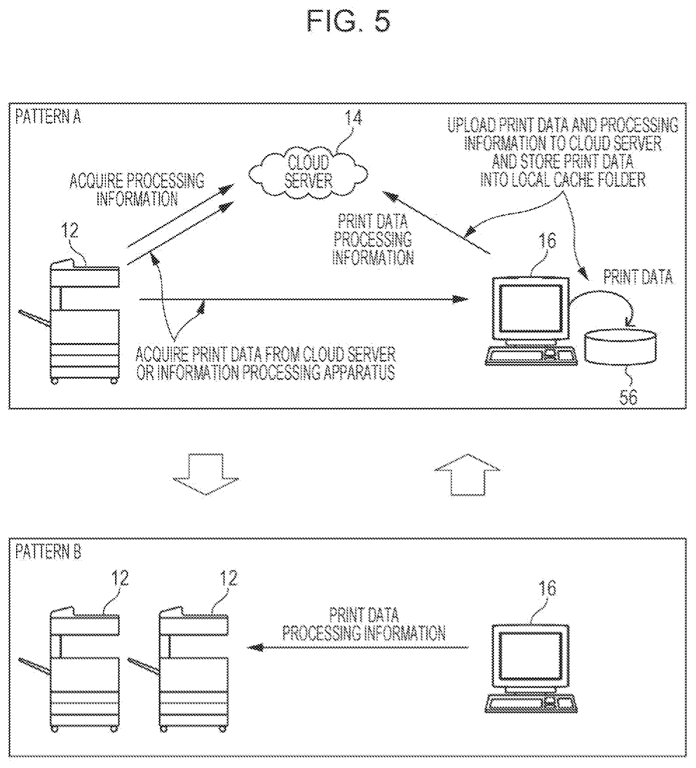

Next, processing patterns based on which printing is performed by the image forming apparatus 12 in the image forming system 10 according to this exemplary embodiment will be described. FIG. 5 is a diagram for explaining examples of processing patterns based on which printing is performed by the image forming apparatus 12 in the image forming system 10 according to this exemplary embodiment.

In the image forming system 10 according to this exemplary embodiment, the image forming apparatus 12 is capable of printing in accordance with two types of processing patterns, that is, pattern A and pattern B.

In this exemplary embodiment, printing is performed in accordance with the pattern A in the case where the information processing apparatus 16 is able to connect to the cloud server 14, and printing is performed in accordance with the pattern B in the case where the information processing apparatus 16 is not able to connect to the cloud server 14.

In the pattern A, the information processing apparatus 16 transmits to the cloud server 14 print data and processing information including access information of the information processing apparatus 16 and information for forming an image represented by the print data, and stores the print data into the local cache folder 56 of the information processing apparatus 16. In printing at the image forming apparatus 12, the image forming apparatus 12 acquires the processing information from the cloud server 14, and acquires the print data from the cloud server 14 or the information processing apparatus 16 to perform printing. Uploading the processing information and the print data to the cloud server 14 and storing the print data into the information processing apparatus 16 are not necessarily performed at the same time. For example, after uploading the processing information and the print data to the cloud server 14, the print data may be stored into the information processing apparatus 16. In this exemplary embodiment, it is assumed that the processing information and the print data are uploaded to the cloud server 14 from the information processing apparatus 16 in accordance with an operation on the information processing apparatus 16 by a user, and after the print data is stored into the information processing apparatus 16, the user moves to the front of the image forming apparatus 12 and performs an operation on the user interface 22, so that printing is performed.

In the pattern B, the processing information and the print data are directly transmitted from the information processing apparatus 16 to the image forming apparatus 12, and the image forming apparatus 12, to which the processing information and the print data are transmitted, performs printing. Alternatively, printing may be performed using an available image forming apparatus 12 on a network, out of preset image forming apparatuses 12, by using a serverless on-demand print (SODP) service in which printing processing transmitted to an image forming apparatus 12 is allowed to be output from another image forming apparatus 12. Furthermore, in the case where the processing information and the print data are directly transmitted to the image forming apparatus 12 from the information processing apparatus 16 in accordance with the pattern B, short range communication (for example, Wi-Fi® or Bluetooth®) may be used.

At the time of uploading the processing information and the print data to the cloud server 14 from the information processing apparatus 16, the timing when the processing information and the print data in the cloud server 14 will be deleted may be selected. For example, a selection may be made among confirming deletion of the processing information and the print data at the time of image formation, not deleting the processing information and the print data, and deleting the processing information and the print data after a predetermined time (for example, fifteen minutes) has passed. Furthermore, a time limit by which print data is to be deleted may be selected for each contract unit such as a tenant. For example, a selection may be made in units of contracts, ranging from an hour to seven days.

Furthermore, the print data stored in the information processing apparatus 16 may be deleted at the time different from the time at which the print data transmitted to the cloud server 14 is deleted. This is because the print data in the information processing apparatus 16 is merely a cache and may be deleted at a time earlier than the time at which the print data in the cloud server 14 is deleted. For example, the print data may be deleted by a predetermined operation of the information processing apparatus 16. Specifically, an the print data may be deleted, as a predetermined operation, at the time when the application 50, which manages the print data in the information processing apparatus 16, ends or starts. Accordingly, as a result, all the print data are deleted at the time of logging out, logging in, and restart. Besides them, the print data in the information processing apparatus 16 may be deleted when a predetermined time (for example, five minutes) has passed.

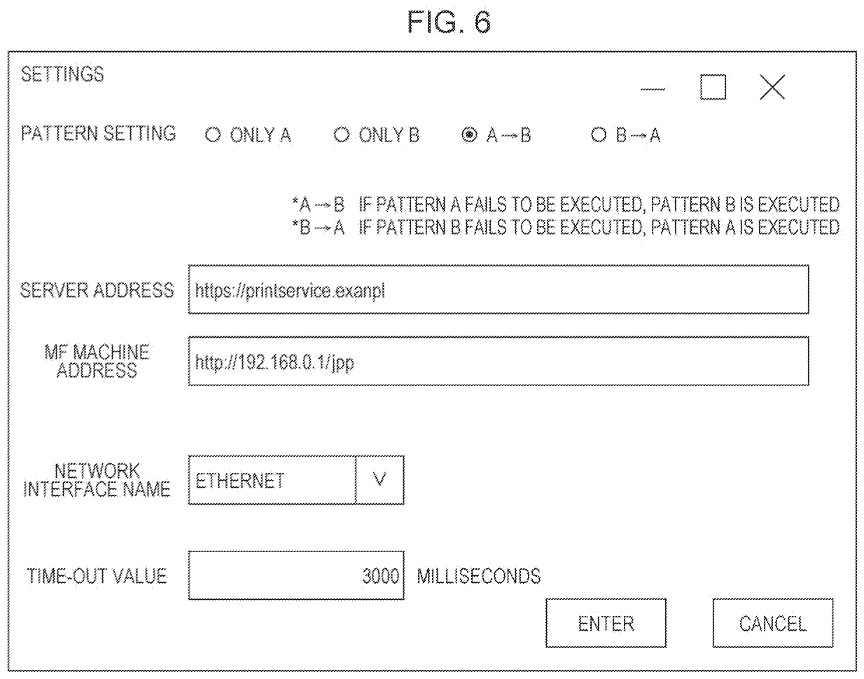

Furthermore, in this exemplary embodiment, a processing pattern used when the image forming apparatus 12 performs printing may be set on a setting screen on the information processing apparatus 16. FIG. 6 is a diagram illustrating an example of a setting screen displayed on the information processing apparatus 16.

In the example of FIG. 6, as pattern setting, selection may be made from among four types: only pattern A (“only A” in FIG. 6); only pattern B (“only B” in FIG. 6); pattern B if pattern A fails (“A→B” in FIG. 6); and pattern A if pattern B fails (“B→A” in FIG. 6). In FIG. 6, an example in which “A→B” is selected illustrated.

Furthermore, on the setting screen illustrated in FIG. 6, the address of the cloud server 14 (server address in FIG. 6), the address of the image forming apparatus 12 (MF machine address in FIG. 6), and a network interface name may be set.

Furthermore, a time-out value for determining whether a processing pattern has failed may be set. When a time set as the time-out value has passed, it is determined that printing has failed.

The server address, the MF machine address, the network interface name, and the time-out value in FIG. 6 may be displayed in the case where an administrator performs an operation and may be non-displayed normally.

In the image forming system 10 according to this embodiment, in the case where the image forming apparatus 12 acquires print data from the information processing apparatus 16 and performs printing of the print data in accordance with the pattern A, if access information of the information processing apparatus 16 is changed after the access information is uploaded to the cloud server 14, print data stored in the local cache folder 56 of the information processing apparatus 16 is not able to be acquired by the image forming apparatus 12 at the time of printing. For example, when a user carrying the information processing apparatus 16 moves to a different location or changes the connection state of a LAN (for example, change from a wireless LAN to a wired LAN), an IP address as access information allocated to the information processing apparatus 16 changes. If the IP address changes, the print data stored in the local cache folder 56 of the information processing apparatus 16 is not able to be acquired by the image forming apparatus 12 at the time of printing.

Thus, in this exemplary embodiment, in the case where a change in the access information is detected, processing for performing an update by transmitting the changed access information to the cloud server 14 is performed.

Specifically, AUTO may be selected on a network interface on a setting screen illustrated in FIG. 6. When AUTO is selected, the resident application 54 starts. Then, the resident application 54 monitors whether there is a change in the routing table of the OS to detect a change in the access information. For example, a network address “0.0.0.0” in the routing table is the address of a default gateway. Since an IP address corresponding to the default gateway changes due to moving of the location, a chance in the connection state of the LAN, or the like, a change in access information is detected by monitoring the IP address corresponding to the default gateway. Monitoring of the routing table may be implemented by polling or event notification from the OS.

When detecting a change in the routing table of the OS, the resident application 54 acquires the IP address corresponding to the default gateway, and transmits the new IP address and the list of document IDs on the local cache folder 56 to the cloud server 14. Then, the cloud server 14 updates IP addresses corresponding to the document IDs. Thus, the image forming apparatus 12 acquires processing information including a changed IP address from the cloud server 14 at the time of printing. Therefore, the image forming apparatus 12 acquires print data stored in the local cache folder 56 of the information processing apparatus 16 and performs printing of the print data.

Furthermore, depending on settings of the OS, there may be no address of the default gateway in the routing table. In this case, an IP address may be acquired from a result of communication with the cloud server 14. Alternatively, an error dialog may be present to a user so that information indicating that the user is not able to acquire an IP address is displayed. Alternatively, the user may be allowed to select a network interface to be used for the current uploading, and a selection result may be received. In the case where no network interface has been selected within a predetermined time or in the case where an instruction for cancellation is issued, print data stored in the local cache folder 56 may be deleted. Alternatively, the user may be allowed to select whether or not to delete the print data, and the print data may be deleted when an instruction for deletion is received.

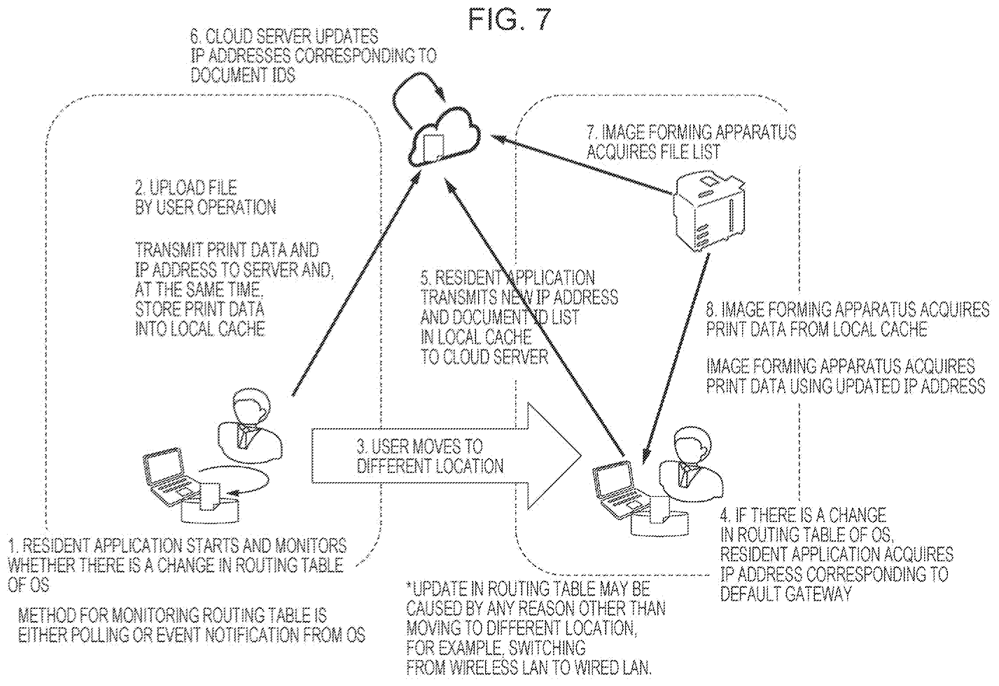

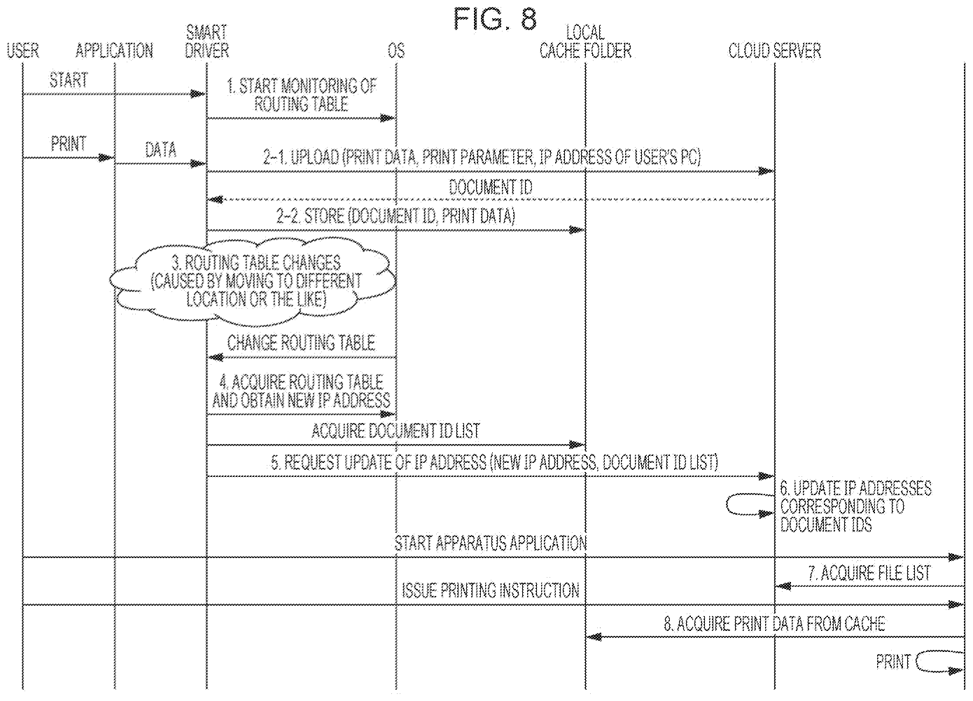

Next, the procedure of a specific process performed in the image forming system 10 according to this exemplary embodiment configured as described above will be described with reference to FIGS. 7 and 8. FIG. 7 is a diagram for explaining an example of the procedure of a process performed in the image forming system 10 according to this exemplary embodiment. FIG. 8 is a sequence diagram illustrating an example of the procedure of a process performed in the image forming system 10 according to this exemplary embodiment.

When the user operates the information processing apparatus 16 to start the resident application 54 of the smart driver 51, the resident application 54 starts monitoring of the routing table of the OS.

Then, when the user operates the information processing apparatus 16 to perform setting for printing in the application 50 and issues a printing instruction, the application 50 transmits the set printing settings to the printer driver 52 of the smart driver 51 and issues an instruction for creating print data.

In response to the instruction for creating print data from the application 50, the printer driver 52 of the smart driver 51 transmits the printing settings to the resident application 54. The resident application 54 checks pattern setting from the printing settings transmitted from the printer driver 52. The resident application 54 performs a process described below in the case where the setting is such that only the pattern A is executed or the pattern B is executed if the pattern A fails to be executed.

That is, the resident application 54 transmits processing information including a document name, printing settings, and the IP address of the information processing apparatus 16 as access information of access, to the information processing apparatus 16 and print data to the cloud server 14. Furthermore, the resident application 54 encrypts, the print data, stores the encrypted print data into the local cache folder 56 of the information processing apparatus 16, and notifies the user of completion of the process. After the processing information is transmitted to the cloud server 14, the processing information is completely deleted or partially deleted. For example, a document ID is not deleted and remains in the information processing apparatus 16 as part of the processing information. The processing information and the print data may be transmitted to the cloud server 14 in the case where user authentication is successfully achieved before the processing information and the print data are transmitted to the cloud server 14.

Next, the procedure of a process performed in the case where, after processing information and data are uploaded to the cloud server 14, the user moves to a different location and the image forming apparatus 12 performs printing of the print data stored in the local cache folder 56 in accordance with the pattern A will be described.

When the user moves to a different location, she resident application 54 of the smart driver 51 detects a change in the routing table of the OS.

When detecting the change in the routing table of the OS, the resident application 54 acquires an IP address corresponding to the default gateway of the routing table.

Furthermore, the resident application 54 acquires the list of document IDs in the local cache folder 56, and transmits the new IP address and the list of the document IDs in the local cache folder 56 to the cloud server 14.

The cloud server 14 updates, of the processing information received from the information processing apparatus 16, IP addresses corresponding to the document IDs in the document ID list received from the resident application 54.

Then, the user moves to the front of the image forming apparatus 12, and operates the user interface 22 to start the apparatus application 64.

The apparatus application 64 requests the cloud server 14 for the list of files. In response to the request from the apparatus application 64 for the list of files, the processing response unit 60 of the cloud server 14 transmits the list of files. Thus, the apparatus application 64 acquires the list of files.

Then, the user operates the user interface 22 to select a file from the list of files and issues a printing instruction to the image forming apparatus 12.

The apparatus application 64 of the image forming apparatus 12 connects to the information processing apparatus 16 using the updated IP address and acquires the print data stored in the local cache folder 56. The updated IP address is acquired along with the list of files. Alternatively, after selection of the file, the image forming apparatus 12 may request the cloud server 14 for processing information regarding the selected file and thus acquire the processing information.

After acquisition of the print data from the local cache folder 56, the apparatus application 64 decrypts the encrypted print data. Then, the apparatus application 64 issues a printing instruction to the image formation platform 66, and the image formation platform 66 thus performs printing.

Furthermore, in the case where the resident application 54 of the smart driver 51 monitors the routing table of the OS and detects a change in the IP address, in uploading of processing information to the cloud server 14 after AUTO is selected as a network interface, the new IP address is transmitted as the UP address of the information processing apparatus 16 to the cloud server 14.

In the foregoing exemplary embodiment, a change in the access information is detected by monitoring the routing table of the OS. However, a change in the access information may be detected by a different method. For example, when the resident application 54 starts, the resident application 54 may communicate with the cloud server 14 and acquire an IP address as access information from a communication result. In this case, the resident application 54 may store an IP address at the last communication and monitor whether there is a change from the last IP address. Furthermore, the resident application 54 may communicate with the cloud server 14 at every predetermined time to acquire an IP address and monitor whether there is a change in the IP address.

In the foregoing exemplary embodiment, the image forming apparatus 12 and the information processing apparatus 16 are connected to the cloud server 14 through the internal communication line 17 and the external communication line 18. However, the image forming apparatus 12, the information processing apparatus 16, and the cloud server 14 are not necessarily connected as described above. For example, the image forming apparatus 12, the information processing apparatus 16, and the cloud server 14 may be connected through a single communication line or may be connected through three or more communication lines.

Furthermore, processes performed by units in the image forming system 10 according to the foregoing exemplary embodiment may be performed by software, hardware, or a combination of software and hardware. Furthermore, processes performed by units in the image forming system 10 may be stored as programs in a storing medium and distributed.

In the embodiments above, the term “processor” refers to hardware in a broad sense. Examples of the processor include general processors (e.g., CPU: Central Processing Unit) and dedicated processors (e.g., CPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
when receiving an image forming instruction issued to an image forming apparatus, transmit image data and processing information to a server, the processing information including access information regarding access to the information processing apparatus and information for forming an image represented by the image data, and store the image data into the information processing apparatus;
when there is a change in the access information, acquire the changed access information and transmits the acquired changed access information to the server; and
perform control for transmitting the image data to the image forming apparatus in response to a request from the image forming apparatus for transmission of the image data.

2. The information processing apparatus according to claim 1, wherein the processor is configured to perform communication with the server and detect a change in the access information from a result of the communication.

3. The information processing apparatus according to claim 1, wherein the processor is configured to detect a change in the access information by detecting a change in a routing table of an operating system.

4. The information processing apparatus according to claim 3, wherein the processor is configured to acquire, as the changed access information, an IP address corresponding to an address of a default gateway of the routing table.

5. The information processing apparatus according to claim 4, wherein the processor is configured to, in a case where there is no address of the default gateway, perform communication with the server and acquire the changed access information from a result of the communication.

6. The information processing apparatus according to claim 4, wherein the processor configured to, in a case where there is no address of the default gateway, provide a notification indicating that the changed access information is not able to be acquired.

7. The information processing apparatus according to claim 4, wherein the processor is configured to, in a case where there is no address of the default gateway, receive a result of selection of a network interface.

8. The information processing apparatus according to claim 7, wherein the processor is configured to, in a case where no network interface is selected, delete the image data stored in the information processing apparatus.

9. The information processing apparatus according to claim 8, wherein the processor configured to delete the image data after receiving an instruction for deleting the image data.

10. An information processing system comprising:
an information processing apparatus;
an image forming apparatus; and
a server that is mole to connect to the information processing apparatus and the image forming apparatus,
wherein the information processing apparatus includes a first processor configured to:
when receiving an image forming instruction issued to the image forming apparatus, transmit image data and processing information to the server, the processing information including access information regarding access to the information processing apparatus and information for forming an image represented by the image data, and store the image data into the information processing apparatus;
when there is a change in the access information, acquire the changed access information and transmit the acquired changed access information to the server; and
perform control for transmitting the image data to the image forming apparatus in response to a request form the image forming apparatus for transmission of the image data,
wherein the image forming apparatus includes a second processor configured to:
acquire the processing information from the server;
acquire the image data by selecting between acquisition of the image data from the server and acquisition of the image data from the information processing apparatus corresponding to the access information; and
perform control such that image formation is performed using the acquired image data and the acquired processing information, and
wherein the server includes a third processor configured to, when receiving the changed access information from the information processing apparatus, update the received access information regarding the processing information to the changed access information.

11. A non-transitory computer readable medium storing a program causing a computer to execute a process for information processing, the process comprising:
when receiving an image forming instruction issued to an image forming apparatus, transmitting image data and processing information to a server, the processing information including access information regarding access to the information processing apparatus and information for forming an image represented by the image data, and storing the image data into the information processing apparatus;
when there is a change in the access information, acquiring the changed access information and transmitting the acquired changed access information to the server; and
performing control for transmitting the image data to the image for apparatus in response to a request from the image forming apparatus for transmission of the image data.
